(19) United States
(12) Patent Application Publication
(10) Pub. No.: US 2013/0218342 A1
(43) Pub. Date: Aug. 22, 2013

(54) CONTROL METHOD FOR CLEANING ROBOTS

(71) Applicants: Leng Yao-Shih, (US); MICRO-STAR INTERNATIONAL COMPANY LIMITED, (US)

(72) Inventors: You-Wei TENG, New Taipei City (TW); Shih-Che HUNG, Hsinchu City (TW); Yao-Shih LENG, Taipei City (TW)

(73) Assignee: MICRO-STAR INTERNATIONAL COMPANY LIMITED, New Taipei City (TW)

(21) Appl. No.: 13/768,026

(22) Filed: Feb. 15, 2013

Related U.S. Application Data
(60) Provisional application No. 61/599,690, filed on Feb. 16, 2012.

(30) Foreign Application Priority Data
Jul. 26, 2012 (TW) 101126911

(51) Int. Cl. G05D 1/02

(52) U.S. Cl. CPC G05D 1/0231; Y10S 901/01
USPC 700/259; 901/1

(57) ABSTRACT

An embodiment of the invention provides a control method of a cleaning robot. The method includes the steps of: forming a cleaning area according to at least three points which are selected from a light generating device, a charging station or an obstacle; moving the cleaning robot along an outer of the cleaning area from a first position; recording a first cleaning route when the cleaning robot returns back to the first position; moving the cleaning robot to a second position and planning a second cleaning route according to the first cleaning route; and moving the cleaning robot along the second cleaning route.

### CROSS REFERENCE TO RELATED APPLICATIONS

This application claims the benefit of U.S. Provisional Application No. 61/599,690 filed Feb. 16, 2012, the entirety of which is incorporated by reference herein.

This application claims priority of Taiwan Patent Application No. 101126911, filed on Jul. 26, 2012, the entirety of which is incorporated by reference herein.

### BACKGROUND OF THE INVENTION

1. Field of the Invention

The invention relates to a cleaning robot, and more particularly, to a cleaning robot with a non-omnidirectional light detector.

2. Description of the Related Art

A variety of movable robots, which generally include a driving means, a sensor and a travel controller, and perform many useful functions while autonomously operating, have been developed. For example, a cleaning robot for the home, is a cleaning device that sucks dust and dirt from the floor of a room while autonomously moving around the room without user manipulation.

### BRIEF SUMMARY OF THE INVENTION

An embodiment of the invention provides a control method of a cleaning robot. The method comprises the steps of: forming a cleaning area according to at least three means which are selected from a light generating device, a charging station or an obstacle; circling along an outline of the cleaning area from a first position by the cleaning robot; recording a first cleaning route when the cleaning robot returns back to the first position; moving the cleaning robot to a second position and planning a second cleaning route according to the first cleaning route; and circling along the second cleaning route by the cleaning robot.

Another embodiment of the invention provides a control method for a cleaning robot. The method comprises the steps of: forming a cleaning area according to at least three means which are selected from a light generating device, a charging station or an obstacle; estimating a center of the cleaning area; moving the cleaning robot to the center of the cleaning area; and moving the cleaning robot in a spiral route and cleaning the cleaning area.

A detailed description is given in the following embodiments with reference to the accompanying drawings.

### BRIEF DESCRIPTION OF THE DRAWINGS

The present invention can be more fully understood by reading the subsequent detailed description and examples with references made to the accompanying drawings, wherein:

FIG. 1 is a schematic diagram of a light generating device and a cleaning robot according to an embodiment of the invention.

FIGS. 2a-2d are schematic diagrams of cleaning route planning methods for a cleaning robot according to embodiments of the invention.

FIG. 3 is a schematic diagram of an embodiment of a cleaning robot according to the invention.

FIG. 4 is a schematic diagram of a control method for a cleaning robot according to another embodiment of the invention.

FIG. 5 is a schematic diagram of a control method for a cleaning robot according to another embodiment of the invention.

FIG. 6 is a flowchart of a cleaning route planning method for a cleaning robot according to an embodiment of the invention.

FIG. 7 is a flowchart of a cleaning route planning method for a cleaning robot according to another embodiment of the invention.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

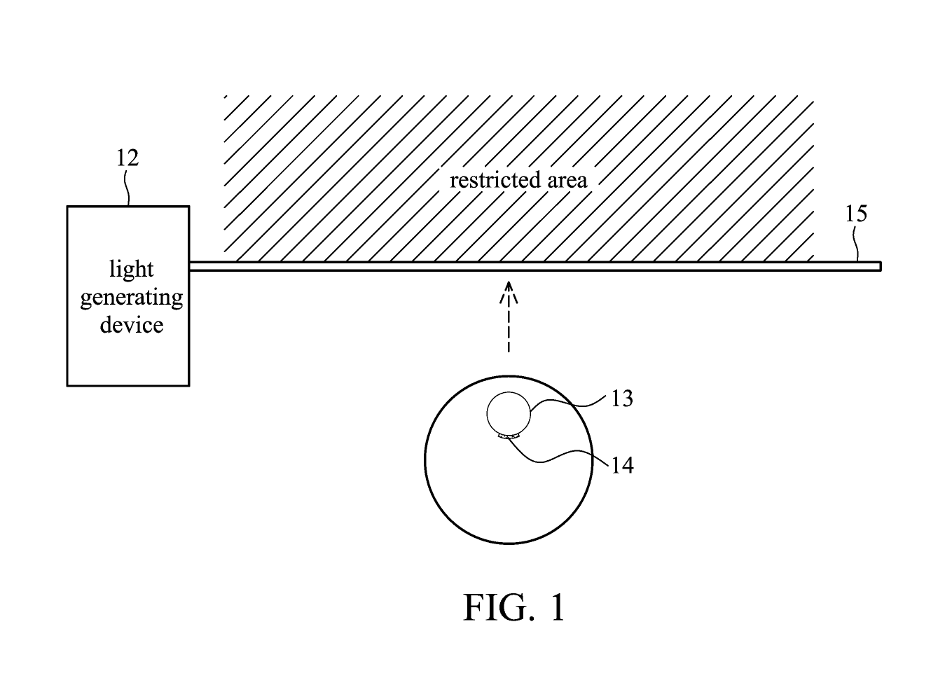

FIG. 1 is a schematic diagram of a light generating device and a cleaning robot according to an embodiment of the invention. The light generating device 12 outputs a light beam 15 to label a restricted area that the cleaning robot 11 cannot enter. The cleaning robot 11 comprises a non-omnidirectional light detector 13 having a rib (or called mask) 14, where the rib 14 produces a shadowed area on the non-omnidirectional light detector 13 by a predetermined angle and the range of the predetermined angle is from 30 degrees to 90 degrees.

The rib 14 may be fixed on the surface of the non-omnidirectional light detector 13 or movable along the non-omnidirectional light detector 13. The rib 14 can be spun in 360 degrees along the surface of the non-omnidirectional light detector 13. In this embodiment, the term, non-omni, is a functional description to describe that the rib 14 causes an area on the surface of the non-omnidirectional light detector 13 and the non-omnidirectional light detector 13 cannot not detect light therein or light to not directly reach that area.

Thus, the non-omnidirectional light detector 13 can be implemented in two ways. The first implementation is to combine an omni-light detector with a rib 14 and the rib 14 is fixed on a specific position of the surface of the omni-light detector. The non-omnidirectional light detector 13 is disposed on a plate that can be spun by a motor. Thus, the purpose of spinning of the non-omnidirectional light detector 13 can be achieved. When the non-omnidirectional light detector 13 detects the light beam, an incident angle of the light beam 15 can be determined by spinning the non-omnidirectional light detector 13.

Another implementation of the non-omnidirectional light detector 13 is implemented by telescoping a mask kit on an omni-light detector, wherein the omni light detector cannot be spun and the masking kit is movable along a predetermined track around the omni light detector. The mask kit is spun by a motor. When the non-omnidirectional light detector 13 detects the light beam 15, the mask kit is spun to determine the incident angle of the light beam 15.

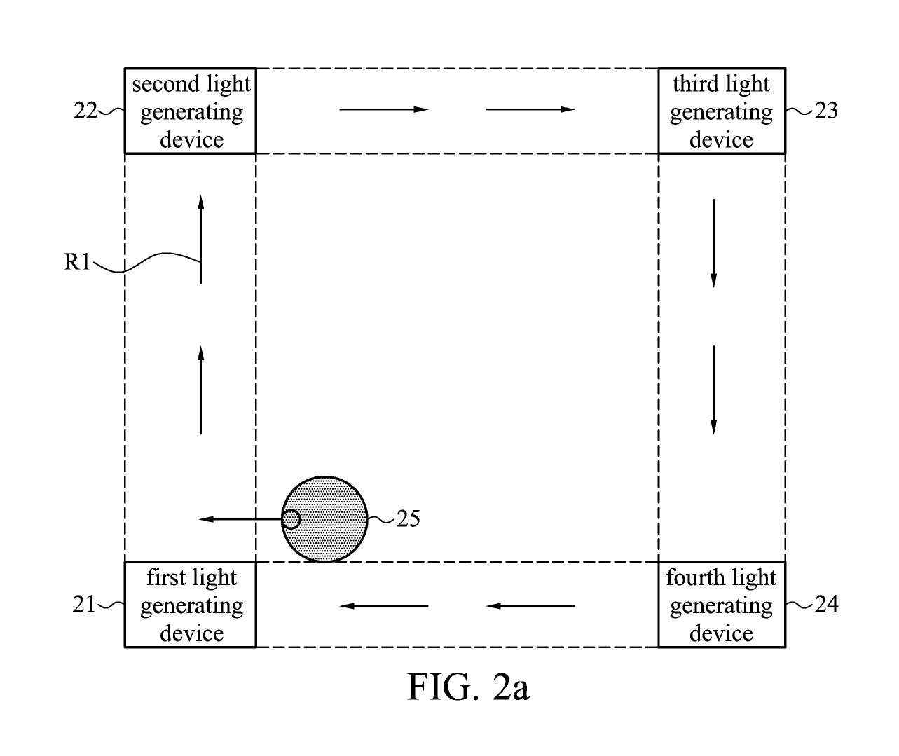

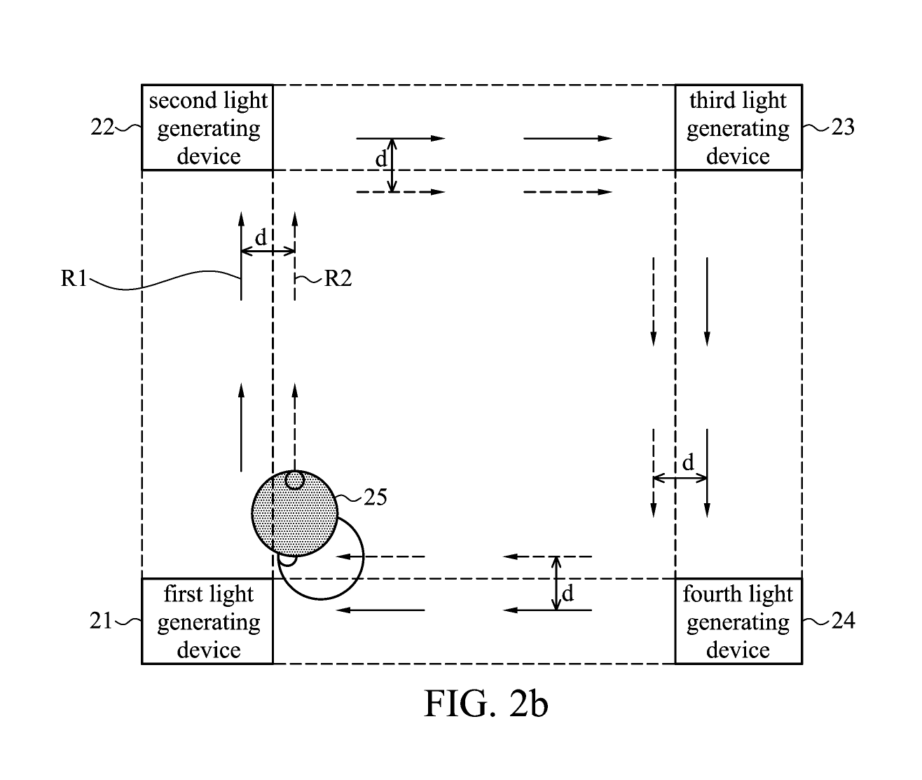

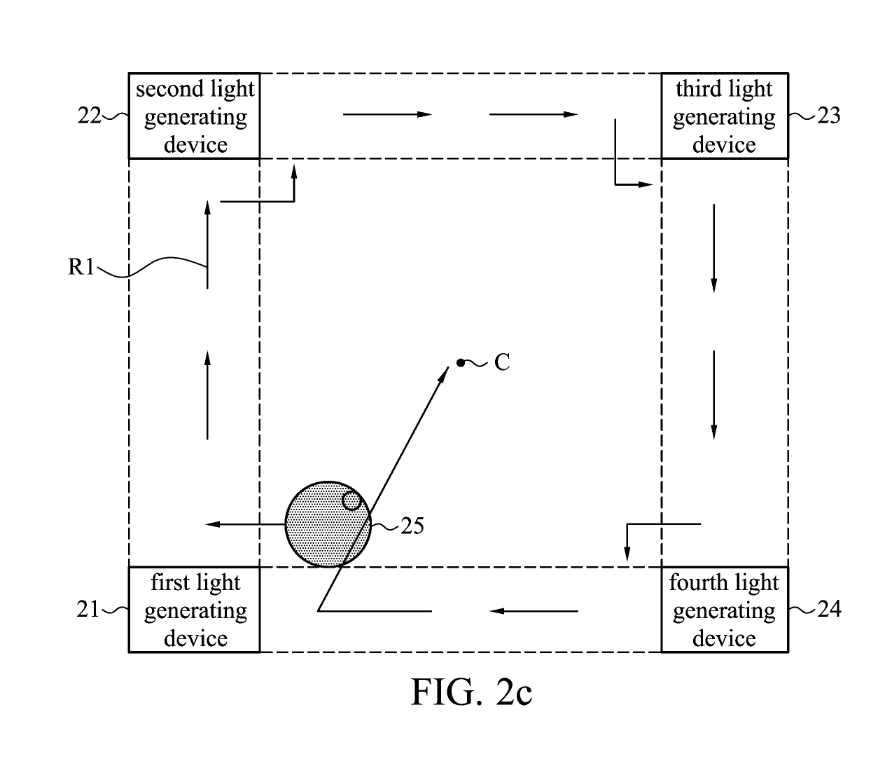

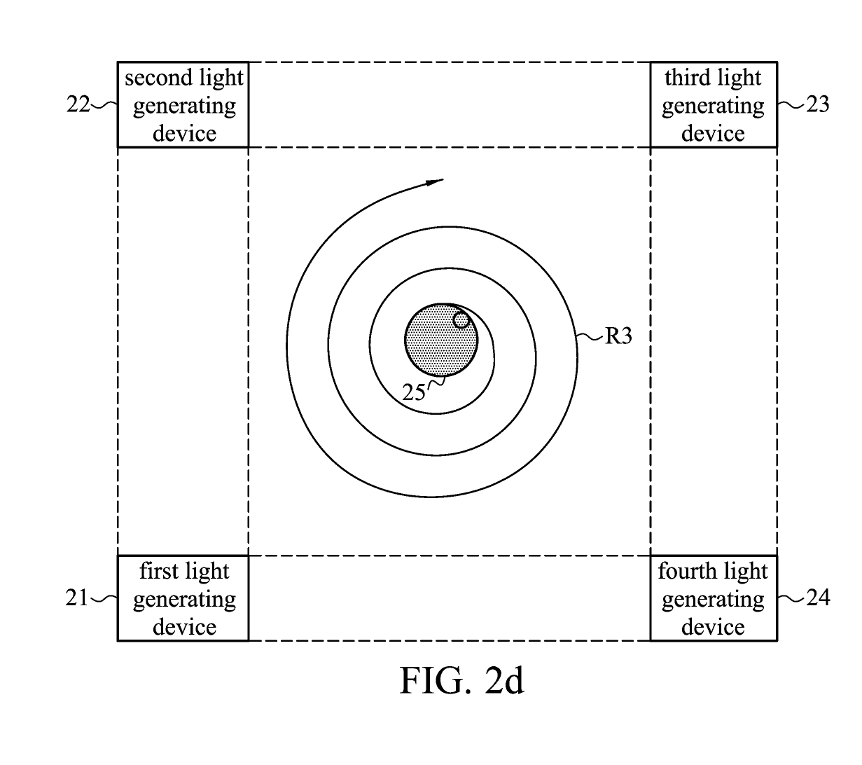

FIG. 2a is a schematic diagram of a cleaning route planning method for a cleaning robot according to an embodiment of the invention. In FIG. 2a, a first light generating device 21, a second light generating device 22, a third light generating device 23 and a fourth light generating device 24 form a closed first region, and the cleaning robot 25 can move only within the first region. The embodiment is illustrated with four light generating devices, but the invention is not limited thereto. In another embodiment, only three or more than three means can form a cleaning area, wherein the means are selected from the light generating device, wall, charging station for the cleaning robot 25 or other device at a fixed position.

In FIG. 2a, the cleaning robot 25 circles along the outline of the first region from the first light generating device 21 and records a cleaning route R1. When the cleaning robot 25 goes back to the starting point, the first light generating device 21, the cleaning robot 25 records positions or coordinates of the first light generating device 21, the second light generating device 22, the third light generating device 23, the fourth light generating device 24, other obstacles or objects at fixed positions on the cleaning route R1. Thus, the cleaning robot 25 can estimate a position of a center of the cleaning area, i.e. the first region, according to the described coordinates.

Refer to FIG. 2b. When the cleaning robot 25 goes back to the starting point, the cleaning robot 25 moves for a distance d to the center of the cleaning area. Then, the cleaning robot 25 circles along the outline of the cleaning area according to the cleaning route R1 and records a cleaning route R2. In this embodiment, the distance d is half of a width of the cleaning robot 25. Assuming the distance between the first light generating device 21 and the second light generating device 22 is D. In FIG. 2b, the cleaning robot 25 only moves for the distance (D-2d) between the first light generating device 21 and the second light generating device 22 along the cleaning route R2. Thus, when the cleaning robot 25 moves from the new starting point to the second light generating device 22, the cleaning robot 25 only moves for the distance (D-2d) and then moves to the third light generating device 23.

Furthermore, the processor of the cleaning robot 25 estimates a second duration that the cleaning robot 25 circles along the cleaning route R2 according to a first duration that the cleaning robot 25 circles along the cleaning route R1. This can prevent the cleaning robot 25 from cleaning the area around the cleaning route R1 repeatedly.

The cleaning robot 25 moves in the way shown in FIG. 2 until the cleaning robot 25 moves to the center of the cleaning area. In another embodiment, the moving manner of the cleaning robot 25 shown in FIG. 2b can be replaced by other moving manners. Please refer to FIGS. 2c and 2d. In FIG. 2c, the cleaning robot 25 first moves to the center C of the cleaning area. Then, the cleaning robot 25 moves along a spiral route from the center C to the outline of the cleaning area. The cleaning robot 25 stops when cleaning all the cleaning areas.

In FIGS. 2a-2d, two moving manners are included. FIG. 2a and FIG. 2b show one moving manner and FIGS. 2a, 2c and 2d show another moving manner. Moreover, when the cleaning robot 25 cleans all the cleaning areas, the cleaning robot 25 moves reversely to clean the cleaning area again. When the cleaning robot moves to the center of the cleaning area according to the moving manner of FIG. 2b, the cleaning robot 25 can choose one moving manner to clean the cleaning area again. The cleaning robot 25 can move reversely to clean the cleaning area until the cleaning robot 25 moves to the starting point as described in FIG. 2a. In another embodiment, the cleaning robot 25 moves in a spiral route, such as shown in FIG. 2d, to clean the cleaning area until the cleaning robot 25 has cleaned all of the cleaning areas.

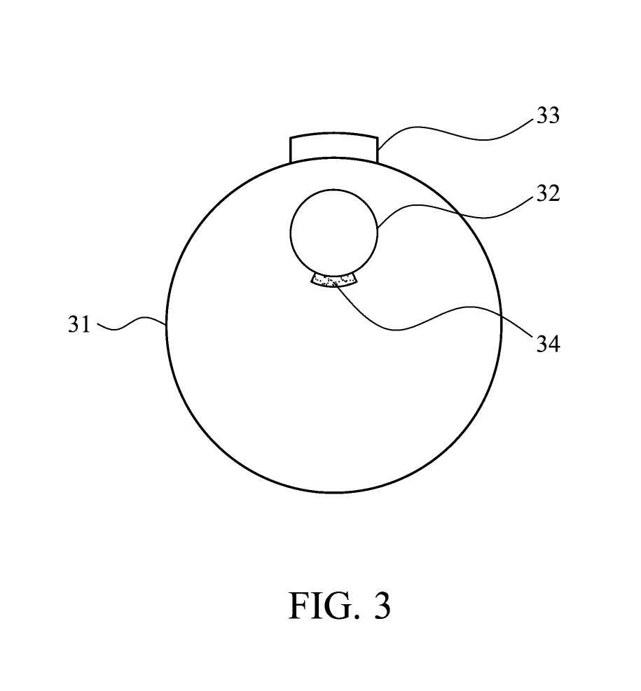

In FIG. 2a, when the cleaning robot 25 detects the light beam output by the light generating device, the cleaning robot 25 is guided by the light beam to move to or move away from the light generating device. Reference can be made to FIGS. 3-5 for the operation where the cleaning robot 25 detects the light beam from the light generating device.

FIG. 3 is a schematic diagram of an embodiment of a cleaning robot according to the invention. The cleaning robot 31 comprises a non-omnidirectional light detector 32, a directional light detector 33 and a mask 34. In FIG. 3, only the elements related to the invention are discussed, but the invention is not limited thereto. The cleaning robot 31 still may comprise other hardware devices, firmware or software for controlling the hardware, which are not discussed for brevity.

When the non-omnidirectional light detector 32 detects a light beam, a controller of the non-omnidirectional light detector 32 or a processor of the cleaning robot 31 first determines the strength of the detected light beam. If the strength of the received signal is less than a predetermined value, the controller or the processor does not respond thereto or take any action. When the strength of the received signal is larger than or equal to the predetermined value, the controller or the processor determines whether the light beam was output by a light generating device.

When the light beam is output by the light generating device, the non-omnidirectional light detector 32 is spun to determine the direction of the light beam or an included angle between the light beam and the current moving direction of the cleaning robot 31. When the direction of the light beam or the included angle is determined, the processor of the cleaning robot 31 determines a spin direction, such as a clockwise direction or counter clockwise direction. The cleaning robot 31 is spun in a circle at the same position. When the directional light detector 33 detects the light beam, the cleaning robot 31 stops spinning.

In another embodiment, when the non-omnidirectional light detector 32 detects the light beam and the light beam is output from the light generating device, the non-omnidirectional light detector 32 and the cleaning robot 31 are spun in the clockwise direction or the counter clockwise direction simultaneously. When the directional light detector 33 detects the light beam, the cleaning robot 31 stops spinning.

In other words, the processor of the cleaning robot 31 controls the cleaning robot 31 to spin in the clockwise direction or the counter clockwise direction according to the detection result of the non-omnidirectional light detector 32. When the directional light detector 33 detects the light beam output by the light generating device, the cleaning robot 31 stops spinning, and the processor of the cleaning robot 31 controls the cleaning robot 31 to move to the light generating device straightforwardly.

Before approaching to the light generating device, the cleaning robot 31 moves along the light beam output by the light generating device and from cleaning the area near the light beam. The processor of the cleaning robot 31 continuously monitors the directional light detector 33 to determine whether the directional light detector 33 receives the light beam output by the light generating device. Once the directional light detector 33 fails to detect the light beam, the cleaning robot 31 is spun to calibrate the moving direction of the cleaning robot 31.

In one embodiment, the directional light detector 33 comprises a plurality of light detection units and the processor slightly calibrates the moving direction of the cleaning robot 31 according to the detection results of the light detection units.

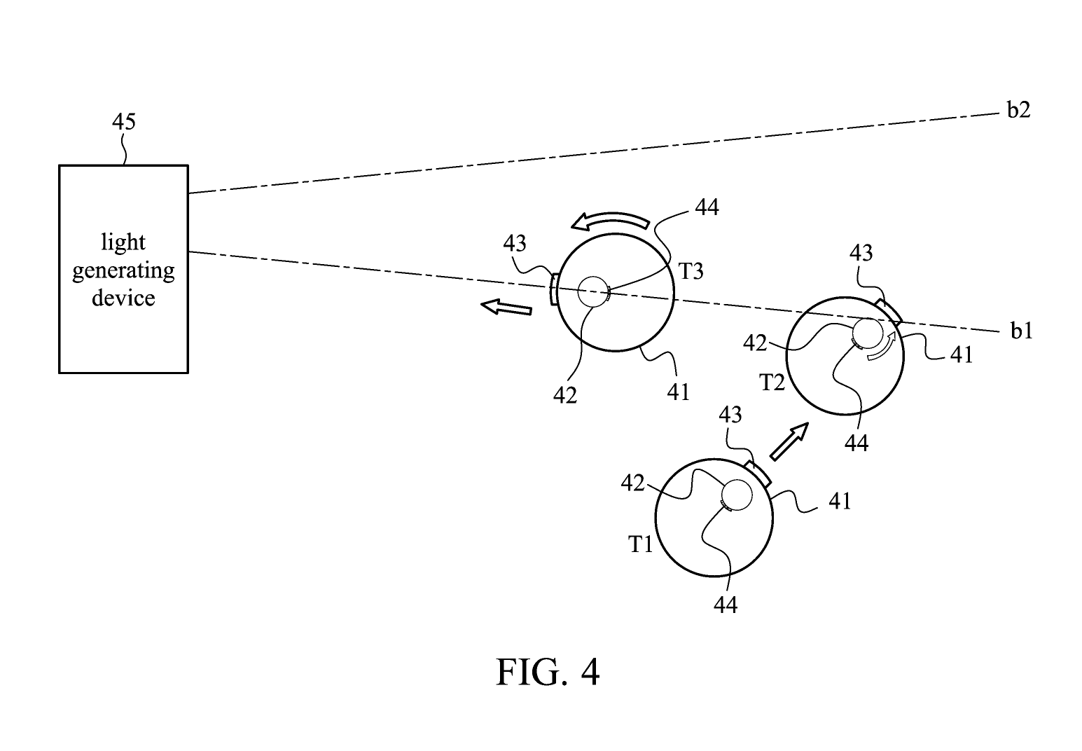

FIG. 4 is a schematic diagram of a control method for a cleaning robot according to another embodiment of the invention. The light generating device 45 outputs a light beam to label a restricted area that the cleaning robot 41 should not enter. In other embodiments, the light generating device 41 is named as light house or light tower and outputs the light beam or other wireless signals. The light beam comprises a first boundary b1 and a second boundary b2. At time T1, the cleaning robot 41 moves along a predetermined route. At time T2, the non-omnidirectional light detector 42 detects a first boundary b2 of a light beam emitted by the light generating device 45. The cleaning robot 41 stops moving, and the non-omnidirectional light detector 42 is spun in a counter clockwise direction or a clockwise direction.

When the mask 44 blocks the light beam emitted from the light generating device 45, the non-omnidirectional light detector 42 cannot detect the light beam. A controller of the cleaning robot 41 records a current position of the mask 44 and estimates a first spin angle of the non-omnidirectional light detector 42 according to an initial position of the mask 44 and the current position of the mask 44 to determine a spin direction of the cleaning robot 41.

For example, assuming the first spin angle is less than 180 degrees, the cleaning robot 41 is spun in the clockwise direction. The cleaning robot 41 is spun in the counter clockwise direction when the first spin angle is larger than 180 degrees.

At time T3, the cleaning robot 41 is spun according to the determined direction until the directional light detector 43 detects the light beam output by the light generating device 45. When the directional light detector 43 detects the light beam output by the light generating device 45, the cleaning robot 41 stops spinning. Generally speaking, when the directional light detector detects the light beam output by the light generating device 45, the light detection units detecting the light beam are located at the margin of the directional light detector 43. Thus, when the cleaning robot 41 moves again, the directional light detector 43 may fail to detect the light beam quickly and the cleaning robot 41 has to stop again to calibrate the moving direction.

To solve the aforementioned issue, in one embodiment, the processor of the cleaning robot 41 estimates a delay time according to the angular velocity of the cleaning robot 41 and the size of the directional light detector 43. When the directional light detector 43 detects the light beam, the cleaning robot 41 stops spinning after the delay time. By the delay time, the light beam output by the light generating device 45 can be detected by the center of the directional light detector 43.

It is noted that the cleaning robot 41 stays at the same position at times T2 and T3. At time T2, the cleaning robot 41 is not moved or spun and only the non-omnidirectional light detector 42 is spun. At time T3, the cleaning robot 41 is spun in a circle at the original position. Although the position of the cleaning robot 41 at time T2 is different from the position of the cleaning robot 41 at time T3 in FIG. 4, it represents only two operations at the same position but at different times. In fact, the position of the cleaning robot 41 does not change at time T2 and T3.

In another embodiment, the operations of the cleaning robot 41 at time T2 and T3 can be integrated in one step. At time T2, the non-omnidirectional light detector 42 is spun in a predetermined direction, and the cleaning robot is also spun in the predetermined direction. When the directional light detector 43 detects the light beam output by the light generating device 45, the cleaning robot 41 stops spinning. When the cleaning robot 41 stops spinning, the non-omnidirectional light detector 42 may be stopped or continues to spin. If the non-omnidirectional light detector 42 is still spinning the processor of the cleaning robot 41 determines the direction of the light beam to calibrate the moving direction of the cleaning robot 41 according to the spin angle of the non-omnidirectional light detector 42.

When the cleaning robot 41 moves to the light generating device 45, the processor of the cleaning robot 41 records the moving paths of the cleaning robot 41 and labels the moving path and a restricted area on a map. In another embodiment, when the processor of the cleaning robot 41 determines the direction of the light beam output by the light generating device, the processor labels the light beam and the restricted area on the map. The map is stored in a memory or a map database of the cleaning robot 41. The processor modifies the map according to the movement of the cleaning robot 41 and labels the positions of obstacles on the map.

When the cleaning robot 41 approaches to the light generating device 45 and the distance between the cleaning robot 41 and the light generating device 45 is less than a predetermined distance, a touch sensor or an acoustic sensor outputs a stop signal to the controller of the cleaning robot 41. The touch sensor or the acoustic sensor is disposed in the front end of the cleaning robot 41 to detect whether there is any obstacle in front of the cleaning robot 41. When the touch sensor or the acoustic sensor detects an obstacle, the cleaning robot 41 first determines whether the obstacle is the light generating device 45. If the obstacle is the light generating device 45, the cleaning robot 41 stops moving and moves in another direction. If the obstacle is not the light generating device 45, the cleaning robot 41 first leaves the original route to prevent the obstacle and returns to the original route after avoiding the obstacle.

When the cleaning robot 41 approaches to the light generating device 45, the light generating device 45 outputs a radio frequency (RF) signal or an infrared signal to let the cleaning robot 41 know that the cleaning robot 41 is close to the light generating device 45. In another embodiment, Near Field Communication (NFC) devices are embedded in both the cleaning robot 41 and the light generating device 45. When the NFC device of the cleaning robot 41 receives signals or data from the NFC device of the light generating device 45, it means that the cleaning robot 41 is close to the light generating device 45 and the cleaning robot 41 should stop accordingly. Generally speaking, the sensing distance of the NFC device is 20 cm.

According to the above description, the cleaning robot 41 can clean the areas near the light beam output by the light generating device 45 and the cleaning robot 41 will not enter a restricted area. Furthermore, the controller of the cleaning robot 41 can draw a map of the cleaning area. When the cleaning robot 1 from cleaning the same area again, the cleaning robot 41 can move according to the map of the cleaning area to complete the cleaning job efficiently and quickly.

Although the embodiment of FIG. 4 is illustrated with the light generating device 45, the invention is not limited thereto. The method of FIG. 4 can be applied to the charging station. The charging station outputs a guiding signal, such as a light beam, to direct the cleaning robot 41 to enter the charging station for charging.

Furthermore, the embodiment of FIG. 4 is illustrated with the non-omnidirectional light detector 42 but the invention is not limited thereto. The non-omnidirectional light detector 42 can be replaced by an acoustic signal detector or other kinds of signal detector.

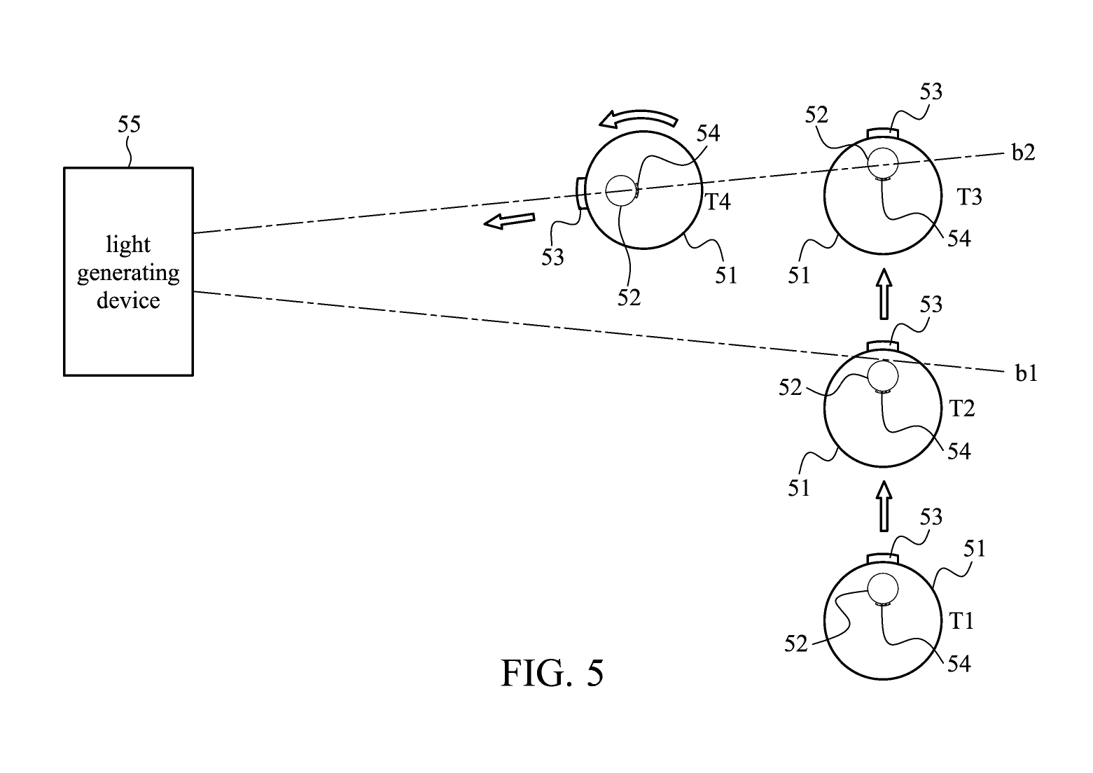

FIG. 5 is a schematic diagram of a control method for a cleaning robot according to another embodiment of the invention. The light generating device 55 outputs a light beam to label a restricted area that the cleaning robot 51 should not enter. In other embodiments, the light generating device 51 is named as light house or light tower and outputs the light beam or other wireless signals. The light beam comprises a first boundary b1 and a second boundary b2. At time T1, the cleaning robot 51 moves along a predetermined route. At time T2, the non-omnidirectional light detector 52 detects a first boundary b2 of a light beam emitted by the light generating device 55. The cleaning robot 51 keeps moving along the predetermined route. At time T3, the non-omnidirectional light detector 52 detects the light beam and the cleaning robot 51 stops moving. The non-omnidirectional light detector 52 is then spun in a counter clockwise direction or a clockwise direction.

When the mask 54 blocks the light beam emitted from the light generating device 54, the non-omnidirectional light detector 52 cannot detect the light beam. A controller of the cleaning robot 51 records a current position of the mask 54 and estimates a first spin angle of the non-omnidirectional light detector 52 according to an initial position of the mask 54 and the current position of the mask 54 to determine a spin direction of the cleaning robot 51.

For example, assuming the first spin angle is less than 180 degrees, the cleaning robot 51 is spun in the clockwise direction. The cleaning robot 51 is spun in the counter clockwise direction when the first spin angle is larger than 180 degrees.

At time T4, the cleaning robot 51 is spun according to the determined direction until the directional light detector 53 detects the light beam output by the light generating device 55. When the directional light detector 53 detects the light beam output by the light generating device 55, the cleaning robot 51 stops spinning. Generally speaking, when the directional light detector detects the light beam output by the light generating device 55, the light detection units detecting the light beam are located at the margin of the directional light detector 53. Thus, when the cleaning robot 51 moves again, the directional light detector 53 may fail to detect the light beam quickly and the cleaning robot 51 has to stop again to calibrate the moving direction.

To solve the aforementioned issue, in one embodiment, the processor of the cleaning robot 51 estimates a delay time according to the angular velocity of the cleaning robot 51 and the size of the directional light detector 53. When the directional light detector 53 detects the light beam, the cleaning robot 51 stops spinning after the delay time. By the delay time, the light beam output by the light generating device 55 can be detected by the center of the directional light detector 53.

It is noted that the cleaning robot 51 stays at the same position at times T3 and T4. At time T3, the cleaning robot 51 is not moved or spun and only the non-omnidirectional light detector 52 is spun. At time T4, the cleaning robot 51 is spun in a circle at the original position. Although the position of the cleaning robot 51 at time T3 is different from the position of the cleaning robot 51 at time T4 in FIG. 4, it represents only two operations at the same position but at different times. In fact, the position of the cleaning robot 51 does not change at time T3 and T4.

In another embodiment, the operations of the cleaning robot 51 at time T3 and T4 can be integrated in one step. At time T3, the non-omnidirectional light detector 52 is spun in a predetermined direction, and the cleaning robot is also spun in the predetermined direction. When the directional light detector 53 detects the light beam output by the light generating device 55, the cleaning robot 51 stops spinning. When the cleaning robot 51 stops spinning, the non-omnidirectional light detector 52 may be stopped or continues to spin. If the non-omnidirectional light detector 52 is still spinning the processor of the cleaning robot 51 determines the direction of the light beam to calibrate the moving direction of the cleaning robot 41 according to the spin angle of the non-omnidirectional light detector 52.

When the cleaning robot 51 moves to the light generating device 55, the processor of the cleaning robot 51 records the moving paths of the cleaning robot 51 and labels the moving path and a restricted area on a map. In another embodiment, when the processor of the cleaning robot 51 determines the direction of the light beam output by the light generating device, the processor labels the light beam and the restricted area on the map. The map is stored in a memory or a map database of the cleaning robot 51. The processor modifies the map according to the movement of the cleaning robot 51 and labels the positions of obstacles on the map.

When the cleaning robot 51 approaches to the light generating device 55 and the distance between the cleaning robot 51 and the light generating device 55 is less than a predetermined distance, a touch sensor or an acoustic sensor outputs a stop signal to the controller of the cleaning robot 51. The touch sensor or the acoustic sensor is disposed in the front end of the cleaning robot 51 to detect whether there is any obstacle in front of the cleaning robot 51. When the touch sensor or the acoustic sensor detects an obstacle, the cleaning robot 51 first determines whether the obstacle is the light generating device 55. If the obstacle is the light generating device 55, the cleaning robot 51 stops moving and moves in another direction. If the obstacle is not the light generating device 55, the cleaning robot 51 first leaves the original route to prevent the obstacle and returns to the original route after avoiding the obstacle.

When the cleaning robot 51 approaches to the light generating device 55, the light generating device 55 outputs a radio frequency (RF) signal or an infrared signal to inform the cleaning robot 51 know that the cleaning robot 51 is close to the light generating device 55. In another embodiment, Near Field Communication (NFC) devices are embedded in both the cleaning robot 51 and the light generating device 55. When the NFC device of the cleaning robot 51 receives signals or data from the NFC device of the light generating device 55, it means that the cleaning robot 51 is close to the light generating device 55 and the cleaning robot 51 should stop accordingly. Generally speaking, the sensing distance of the NFC device is 20 cm.

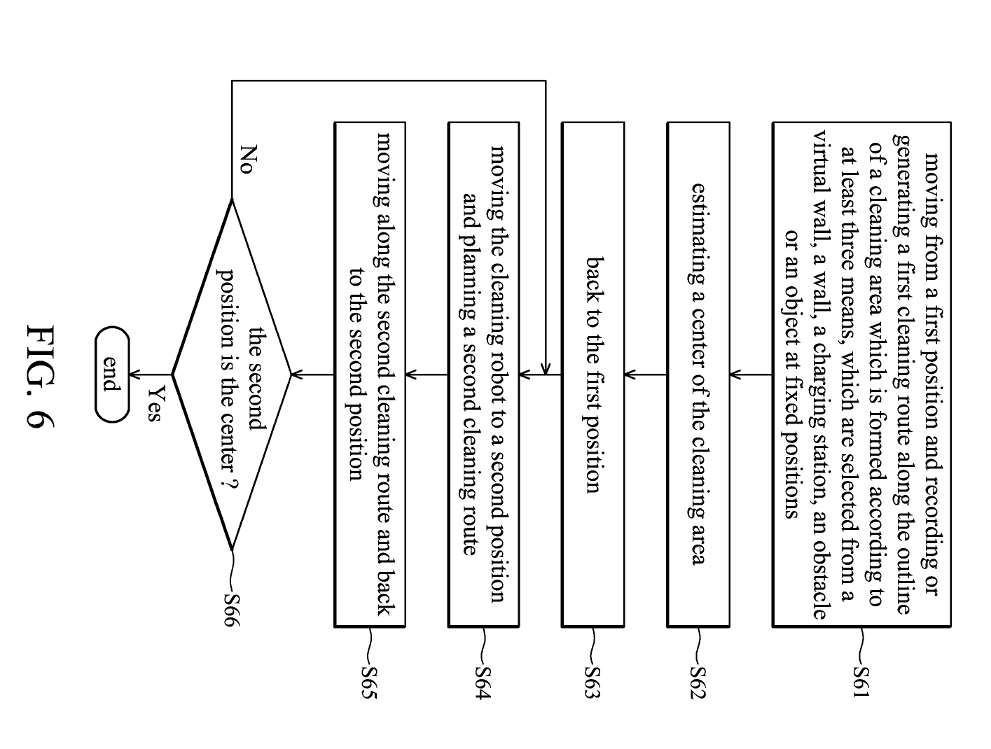

FIG. 6 is a flowchart of a cleaning route planning method for a cleaning robot according to an embodiment of the invention. In the step S61, the cleaning robot plans a cleaning area according to at least three means, which are selected from a light generating device, a wall, a charging station, an obstacle or an object at fixed positions. The light generating device, the wall, the charging station, the obstacle or the object may be an endpoint of the cleaning area or form a boundary of the cleaning area. The embodiment of FIG. 6 is illustrated with the cleaning robot shown in FIG. 3.

In the step S62, the cleaning robot estimates a center of the cleaning area. Then, the cleaning robot circles along the outline of the cleaning area from a first position. In another embodiment, the cleaning robot is placed near to one of the light generating device, the wall, the charging station, the obstacle or the object and circles along the outline of the cleaning area.

When the cleaning robot moves within the cleaning area and detects the light beam output by the light generating device, the cleaning robot moves to or moves away from the light generating device along the light beam. Reference can be made to FIG. 4 or FIG. 5 for the detailed operation of the cleaning robot detecting the light beam.

In step S63, the cleaning robot moves back to the first position and records a first cleaning route. In the step S64, the cleaning robot plans a second cleaning route according to the first cleaning route. Reference can be made to FIG. 2b for the planning method of the second cleaning route. At first, the cleaning robot moves from the first position to a second position for a distance d. Then, the cleaning robot circles along the inter line of the first cleaning route. In this embodiment, the distance d is preset to be half of a width of the cleaning robot.

In the step S65, the cleaning robot returns back to the second position. In the step S66, the cleaning robot first determines whether the second position is the center of the cleaning area or a distance between the second position and the center of the cleaning area is less than the distance d. If yes, the cleaning robot finishes its work. Then the cleaning robot can move to the charging station or move reversely to clean the cleaning area again. If not, step S64 is executed and the cleaning robot moves the distance d to the center of the cleaning area and then moves according to the second cleaning route.

In one embodiment, the step S66 can be integrated in the step S64. When the cleaning robot moves to the second position, the cleaning robot first determines whether the second position is the center of the cleaning area or a distance between the second position and the center of the cleaning area is less than the distance d. If yes, the cleaning robot finishes its work and does not need to plan the second cleaning route. If not, the cleaning robot continues to execute its work.

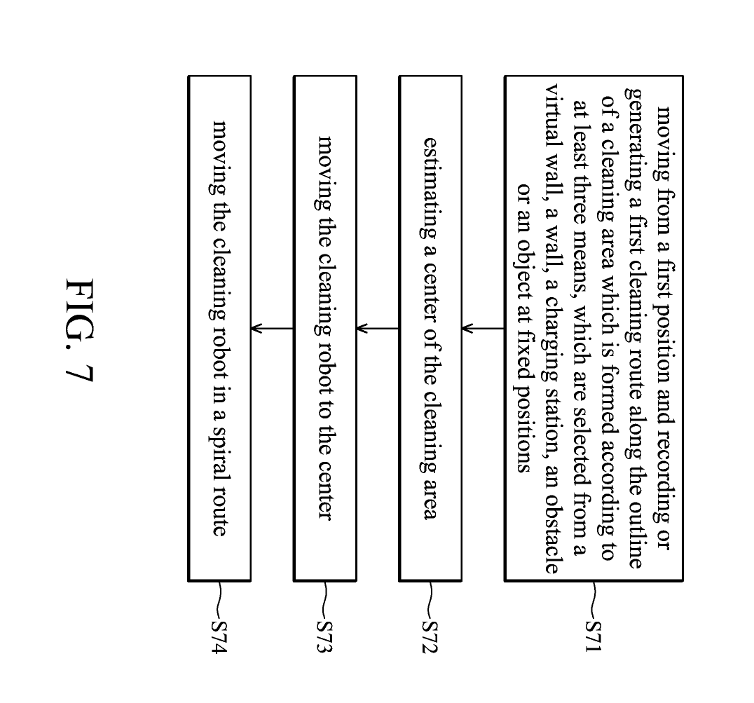

FIG. 7 is a flowchart of a cleaning route planning method for a cleaning robot according to another embodiment of the invention. In the step S71, the cleaning robot plans a cleaning area according to at least three means, which are selected from a light generating device, a wall, a charging station, an obstacle or an object at fixed positions. The light generating device, the wall, the charging station, the obstacle or the object may be an endpoint of the cleaning area or form a boundary of the cleaning area. The embodiment of FIG. 7 is illustrated with the cleaning robot shown in FIG. 3.

In the step S72, the cleaning robot estimates a center of the cleaning area. Then, the cleaning robot moves to the center, such as shown in FIG. 2c. Then, in the step S74, the cleaning robot moves and cleans the cleaning area in a spiral route.

When the cleaning robot moves within the cleaning area and detects the light beam output by the light generating device, the cleaning robot moves to or moves away from the light generating device along the light beam. Reference can be made to FIG. 4 or FIG. 5 for the detailed operation of the cleaning robot detecting the light beam.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A control method for a cleaning robot, comprising:
forming a cleaning area according to at least three means which are selected from a light generating device, a charging station or an obstacle;
circling along an outline of the cleaning area from a first position;
recording a first cleaning route when the cleaning robot returns back to the first position;
moving the cleaning robot to a second position and planning a second cleaning route according to the first cleaning route; and
circling along the second cleaning route.

2. The method as claimed in claim 1, wherein a distance between the first position and the second position is a first distance.

3. The method as claimed in claim 2, wherein the first distance is half of a width of the cleaning robot.

4. The method as claimed in claim 1, further comprising:
estimating a center of the cleaning area,
wherein when the second position is the center of the cleaning area, the cleaning robot does not move along the second route and finishes its work.

5. The method as claimed in claim 1, further comprising:
estimating a center of the cleaning area,
wherein when a distance between the second position and the center of the cleaning area is less than a predetermined distance, the cleaning robot does not move along the second route and finishes its work.

6. The method as claimed in claim 5, wherein the predetermined distance is half of a width of the cleaning robot.

7. The method as claimed in claim 1, further comprising:
when the cleaning robot detects a light beam output by the light generating device, the cleaning robot moving along the light beam.

8. A control method for a cleaning robot, comprising:
forming a cleaning area according to at least three means which are selected from a light generating device, a charging station or an obstacle;
estimating a center of the cleaning area;
moving the cleaning robot to the center of the cleaning area; and
moving the cleaning robot in a spiral route and cleaning the cleaning area.

9. The method as claimed in claim 8, further comprising:
when the cleaning robot detects a light beam output by the light generating device, the cleaning robot moving along the light beam.
